(19) United States
(12) Patent Application Publication
(10) Pub. No.: US 2009/0218535 A1
(43) Pub. Date: Sep. 3, 2009

(54) FLOW CONTROLLERS FOR FLUID CIRCUITS

(76) Inventor: Andres Pasko, Genoa City, WI (US)

Correspondence Address: COOK ALEX LTD., 200 WEST ADAMS STREET, SUITE 2850, CHICAGO, IL, 60606, US

(21) Appl. No.: 12/394,358

(22) Filed: Feb. 27, 2009

Related U.S. Application Data
(60) Provisional application No. 61/031,839, filed on Feb. 27, 2008.
(60) Provisional application No. 61/031,851, filed on Feb. 27, 2008.
(60) Provisional application No. 61/031,861, filed on Feb. 27, 2008.

(51) Int. Cl. F16K 5/08

(52) U.S. Cl. 251/309

(57) ABSTRACT

Flow controllers for controlling flow through a fluid circuit are disclosed. The flow controllers disclosed can close an open flow through a fluid circuit or divert flow from one destination to another.

### CROSS-REFERENCE TO RELATED APPLICATIONS

This application claims the benefit of U.S. Provisional Patent Application Ser. No. 61/031,839 filed Feb. 27, 2008; U.S. Provisional Patent Application 61/031,851 filed Feb. 27, 2008; and U.S. Provisional Patent Application Ser. No. 61/031/861, filed Feb. 27, 2008, all of which are incorporated herein by reference in their entireties.

### BACKGROUND

The present disclosure relates to devices for controlling and/or diverting the fluid flow within a fluid circuit, and to systems employing such flow controllers. The flow controllers described herein may find application in any environment or field where the ability to control fluid flow from a source to one or more a destinations is desired or required. The flow controllers and the systems using such flow controllers find particular application in the medical field and, more specifically, in the field of collecting and processing blood collected from a donor.

In that regard, a disposable plastic container and tubing set or fluid circuit is typically used for collecting blood from a donor. The disposable blood collection set or circuit includes a venipuncture needle for insertion into the arm of the donor. The needle is attached to one end of a flexible plastic tube which provides a flow path for the blood. The flow path communicates with one or more plastic containers for collecting the withdrawn blood.

The blood collection circuit may typically include a sampling sub-unit. The sampling sub-unit allows for collection of a sample of blood, which sample can be used for testing of the blood. Preferably, the sample is obtained prior to the “main” collection of blood. Collecting the sample prior to the main collection reduces the risk that bacteria residing on the donor's skin where the needle is inserted (i.e., in particular, the small section of detached skin commonly referred to as the “skin plug”) will enter the collection container and contaminate the blood collected for transfusion. Thus, it is preferred that the blood sample, which may include the skin plug, be diverted from the main collection container.

Examples of blood collection sets or circuits with such a “pre-donation” sampling sub-units are described in U.S. Pat. Nos. 6,387,086 and 6,520,948 and in U.S. Patent Application Publication Nos. 2005/0215975 and 2005/0148993, all of which are hereby incorporated herein by reference. The fluid processing circuits described therein are similar to the circuit 10 illustrated in FIG. 1. Fluid processing circuit 10 includes venipuncture needle 12 and a length of tubing 14, defining a flow path, one end of which communicates with needle 12 and the other end of which communicates with the inlet port of a Y-junction 16. The fluid circuit also includes two additional flow paths 18 and 20 which are branched from the outlet ports of the Y-junction 16. The first branched line 18 communicates with a sample pouch 20 for collecting a smaller volume of blood from which samples may be obtained. Typically, approximately 50 ml of blood is a sufficient amount to provide an adequate sample size and to clear the skin plug from the tubing set. The second branched line 20 communicates with the main collection container 24 that is typically adapted to collect a larger quantity of blood than the sample pouch 20 after the initial sample has been taken. Fluid processing circuit 10 may also include additional satellite containers 26 and 28 for further processing of the collected blood.

The blood collection circuit 10 of FIG. 1 also includes flow control clamps 34, for controlling the flow of biological fluid (e.g., blood) through the set. The three ports of the Y-junction 16 are always open, so the tubing associated with each must include separate means for regulating flow therethrough. Flow control clamps commonly used are the Roberts-type clamps, which are well known in the art. Clamps of this type are generally described in U.S. Pat. Nos. 3,942,228; 6,089,527; and 6,113,062, all of which are hereby incorporated herein by reference. The clamp described in U.S. Patent Application Publication No. 2005/0215975 may instead be used in operations where it is desirable to irreversibly close flow through a flow path.

The clamps 34 are typically placed on the tubing line 14 leading to the Y-junction 16 and on the tubing line 18 leading to the sample pouch 20, respectively. A clamp may also be placed on the tubing line 20 leading to the main collection container 28, but flow through that tubing line 20 is frequently regulated by a breakaway (frangible) cannula 36, as illustrated in FIG. 1. By selectively opening and closing the different flow paths (by depressing or releasing the clamps or breaking the frangible cannula), the technician can control the flow of blood from the donor, diverting the blood to the desired output zone.

In a typical application, the clamp 34 on the initial length of tubing 12 is closed and venipuncture is performed on the donor. Thereafter, the clamps 34 are opened to allow a small amount of blood to be collected in the sample pouch 20 for later analysis and to clear the skin plug. When the desired amount of blood has been collected in the sample pouch 20, the clamp 34 between the Y-junction 16 and the sample pouch 20 is closed and the breakaway cannula 36 is broken to allow blood flow to the main collection container 24. Flow to the sample pouch 20 should be permanently closed, in order to prevent the skin plug from migrating into the main collection container 24 and to prevent anticoagulant from migrating to the sample pouch 20 from the main collection container 24.

Clearly, the above-described process involves several steps and the manipulation of a number of different components, such as clamps and frangible cannulas. Therefore, there exists a need for improved and easy to operate flow controllers and methods that reduce the number of components in the blood collection sets (e.g., clamps and frangible cannulas) and reduce the number of steps that the operator is required to remember and perform, thereby simplifying the process of collecting separate amounts of blood.

### SUMMARY

The present disclosure is directed to a flow controller assembly that includes an inlet member and outlet member cooperatively associated with each other and adapted for relative rotation about a central axis. The flow controller also includes a sealing member carried by one of said inlet or outlet members. The sealing member includes a single flow channel extending therethrough.

The present disclosure is also directed to a fluid processing circuit that includes a first flow path adapted for communication with a fluid source and a second flow path. The circuit includes a flow controller assembly between the first and second flow paths. The flow controller includes a first portion and a second portion cooperatively associated with each other and adapted for relative rotation about a central axis. The flow controller assembly also includes a sealing member between the portions and carried by one of the portions. The sealing member has a single flow channel extending therethrough. The flow controller assembly includes an inlet port communicating with the first flow path and an outlet port communicating with the second path.

### BRIEF DESCRIPTION OF THE DRAWINGS

FIG. 1 is a plan view of disposable fluid circuit typically used for collecting and processing blood from a donor.

FIG. 2 is a plan view of a fluid processing circuit used for collecting and processing blood from a donor including a flow controller assembly as described herein.

FIG. 3 is a perspective view of one embodiment of a flow controller assembly described herein.

FIG. 4 is an exploded view of the flow controller assembly of FIG. 3.

FIG. 5 is a cross-sectional view of the flow controller assembly of FIG. 3 taken along line 5-5.

FIG. 6 is a plan view of the flow controller assembly of FIG. 3.

FIG. 7 is a plan view of the flow controller assembly of FIG. 6 rotated 90°.

FIG. 7(a) is an inlet end view of the flow controller assembly of FIG. 7.

FIG. 7(b) is the outlet end view of the flow controller assembly of FIG. 7.

FIG. 7(c) is a cross-sectional view of the flow controller of FIG. 7(b) taken along line 7(c)-7(c).

FIG. 7(d) is a cross-sectional view of the flow controller of FIG. 7(b) taken along line 7(d)-7(d).

FIG. 8 is a perspective view of the sealing member of the flow controller of FIG. 7.

FIG. 8(a) is a plan view of the sealing member of FIG. 8.

FIG. 8(b) is a proximal end view of the sealing member of FIG. 8.

FIG. 8(c) is a side view of the sealing member of FIG. 8.

FIG. 8(d) is a distal end view of the sealing member of FIG. 8.

FIG. 9 is a plan view of another embodiment the flow control assembly described herein including a single inlet and dual outlets.

FIG. 10 is a plan view of the flow control assembly of FIG. 9 rotated approximately 90°.

FIG. 10(a) is an inlet end view of the flow control assembly of FIG. 10.

FIG. 10(b) is the outlet end view of the flow control assembly of FIG. 10.

FIG. 10(c) is a cross-sectional view of the flow controller of FIG. 10(b) taken along line 10(c)-10(c).

FIG. 10(d) is a cross-sectional side view of the flow controller of FIG. 10(b) taken along lines 10(d)-10(d).

FIG. 11 is an embodiment of another embodiment of flow controller assembly described herein including a single inlet and single outlet.

FIG. 12 is a plan view of the flow controller assembly of FIG. 11 rotated 90°.

FIG. 12(a) is an inlet end view of the flow controller of FIG. 12.

FIG. 12(b) is an outlet end view of the flow controller of FIG. 12.

FIG. 12(c) is a cross-sectional side view of the flow controller of FIG. 12(b) taken along line 12(c)-12(c).

FIG. 12(d) is a cross-sectional side view of the flow controller of FIG. 12(b) taken along line 12(d)-12(d).

FIG. 13 is a plan view of another embodiment of the flow controller assembly disclosed herein including a single non-centered inlet and three outlets.

FIG. 14 is a plan view of the flow control assembly of FIG. 13 rotated 90°.

FIG. 14(a) is an inlet end view of the flow controller of FIG. 14.

FIG. 14(b) is an outlet end of the flow controller of FIG. 14.

FIG. 14(c) is a cross-sectional view of the flow controller FIG. 14(b) taken along line 14(c)-14(c).

FIG. 14(d) is a cross-sectional view of the flow controller of FIG. 14(b) taken along line 14(d)-14(d).

FIG. 15 is a perspective view of the sealing member of flow control assembly of FIG. 13.

FIG. 15(a) is a side view of the sealing member of FIG. 15.

FIG. 15(b) is an inlet end view of the sealing member of FIG. 15.

FIG. 15(c) is a side view of the sealing member of FIG. 15(b).

FIG. 15(d) is an outlet end view of the sealing member FIG. 15(c).

FIG. 16 is a plan view of another embodiment of the flow control assembly described herein.

FIG. 17 is a plan view of the flow control assembly of FIG. 16 rotated 90°.

FIG. 17(a) is an inlet end view of the flow controller of FIG. 17.

FIG. 17(b) is an outlet end view of the flow controller of FIG. 17.

FIG. 17(c) is a cross-sectional view of the flow controller of FIG. 178 taken along line 17(c)-17(c).

FIG. 17(d) is a cross-sectional view of the flow control assembly of FIG. 17 taken along line 17(d)-17(d).

FIG. 18 is another embodiment of the flow controller assembly described herein.

FIG. 19 is a plan view of the flow control assembly of FIG. 18 rotated 90°.

FIG. 19(a) is an inlet end view of the flow controller of FIG. 19.

FIG. 19(b) is an outlet end view of the flow controller of FIG. 19.

FIG. 19(c) is a cross-sectional view of the flow controller of FIG. 19 taken along lines 19(c)-19(c).

FIG. 19(d) is a cross-sectional view of the flow controller of FIG. 19 taken along FIG. 19(d)-19(d).

FIG. 20 is a cross-sectional view of another embodiment of a flow controller described herein with the flow control button in a first position.

FIG. 21 is a cross-sectional view of the flow controller of FIG. 20 with the button depressed to the second flow position.

FIG. 22 is another embodiment of the flow controller of FIG. 20 including a single inlet and single outlet with the flow control button in the open flow position.

FIG. 23 is the flow controller of FIG. 22 with the button in the depressed to the closed flow position.

FIG. 23A is a perspective view of the button of FIGS. 21-23.

FIG. 24 is another embodiment of a flow controller described herein with the controller in a closed flow position.

FIG. 25 is a cross-sectional view of the flow controller of FIG. 24 as the controller is moved from the closed flow position to the open flow position.

FIG. 26 is a cross-sectional side view of the flow controller of FIGS. 24 and 25 in an open flow position.

FIG. 27 is a view of the mold for making the flow controller of FIGS. 24-25.

FIG. 28 is a cross-sectional view of the mold with core pins being removed from the mold.

FIG. 29 shows an alternative method of molding the flow controller of FIGS. 24-26.

FIG. 30 is a view of the molding operation of FIG. 29 with the core pins being removed from the mold.

FIG. 31 is a cross-sectional view of the flow controller of FIGS. 24-26 after molding.

FIG. 32 is a cross-section view of the flow controller of FIG. 31 with a cap.

FIG. 33 is a cross-sectional view of the flow controller of FIG. 32 with an additional membrane placed thereon.

### DETAILED DESCRIPTION OF THE EMBODIMENTS

The flow controller assembly and flow controllers generally described herein provide a way to divert flow from one destination to another destination and/or provide an easy-to-use on/off switch for selectively opening and restricting flow through a flow path of a fluid circuit. Typically, use of the flow controller assemblies and flow controllers described herein will result in elimination of multiple clamps and frangible devices. The flow controllers described herein may be used in any environment where it is desirable to restrict or otherwise divert flow within a fluid circuit. More specifically, the flow controllers and flow controller assemblies of the present disclosure find particular application and use in the medical field and even more particularly in the field of blood processing and collection where control and diversion of fluid flow is often desired.

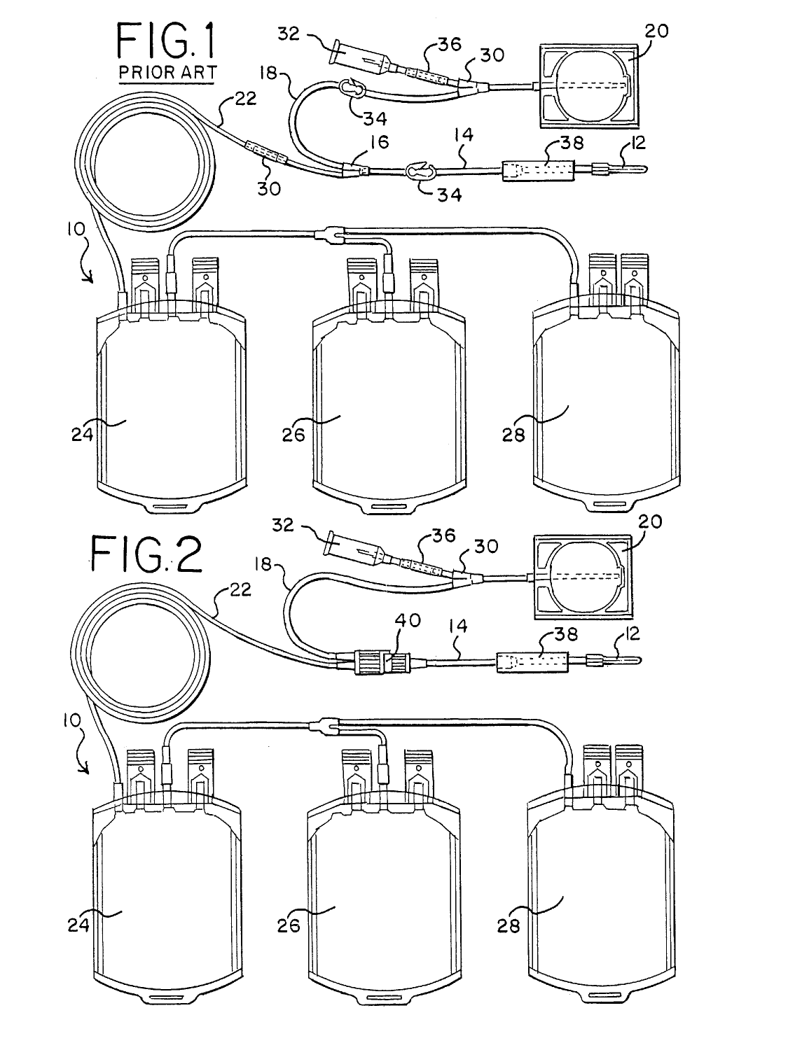

Thus, as shown in FIG. 2, a fluid processing circuit 10 includes a first flow path defined by tubing 14 that communicates with a fluid source, such as a donor, through venipuncture needle 12. Fluid processing circuit 10 includes a flow controller 40 that communicates with the first flow path defined by tubing 14. Specifically, flow path 14 communicates with an inlet port of flow controller 40. As shown in FIG. 2 and in more detail in later figures, flow controller assembly includes one or more outlets that communicate with second (and other) flow paths. These flow paths, defined by tubings 18 and 22 communicate with containers (20, 24) of the fluid processing system as previously described. Flow controller 40 allows the user to direct and/or divert flow to a second or other flow path as necessary.

Turning to FIG. 2, a fluid processing system used in the processing of blood or other biological fluids with a flow controller of the type described herein is shown. In many respects, fluid circuit 10 of FIG. 2 is identical to the fluid circuit shown in FIG. 1. Accordingly, identically numbered elements in FIG. 2 refer to the same element described with reference to FIG. 1. It should be noted, however, that in lieu of branch member 16, clamp 34 and frangible device 36, a flow controller or flow controller assembly 40 as described below may be employed. Of course, it will be understood by those of skill in the art that clamps 34 and frangibles 36 may still be used to provide additional means for fluid control.

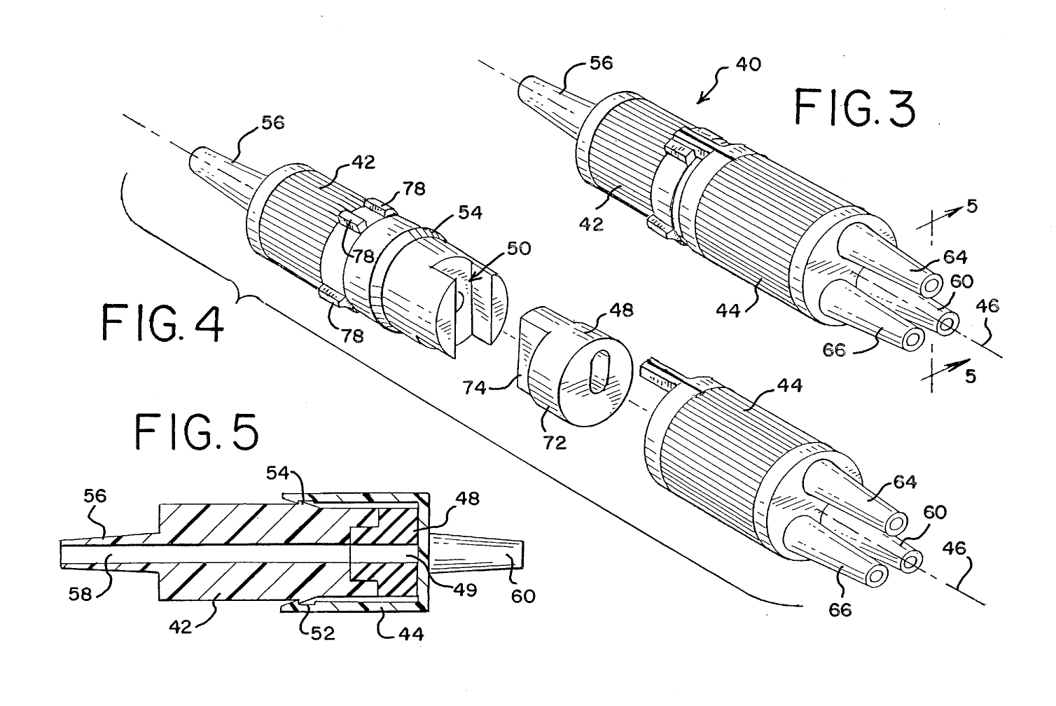

Flow controller assembly 40 shown in FIG. 3 is one embodiment of a flow control device or flow controller that is the subject of the present disclosure. Flow controller assembly 40 is shown in greater detail in FIGS. 3-5. As shown in these figures, flow controller assembly 40 is made of several interconnected and moveable parts, Flow controller assembly 40 includes a first portion such as an inlet member 42, a second portion such as an outlet member 44 and a sealing member 48 disposed between inlet member 42 and outlet member 44. Inlet member 42 includes an inlet port 46 which, with reference to FIG. 2 and as described above, is in flow communication with fluid flow path 14. Turning briefly to FIG. 5, inlet member 42 further defines an inlet channel 58 that extends from port 56 to sealing member 48. Thus, in the case of the blood processing system of FIG. 2, an uninterrupted flow path may be provided from the donor through needle 12 to flow controller assembly 40.

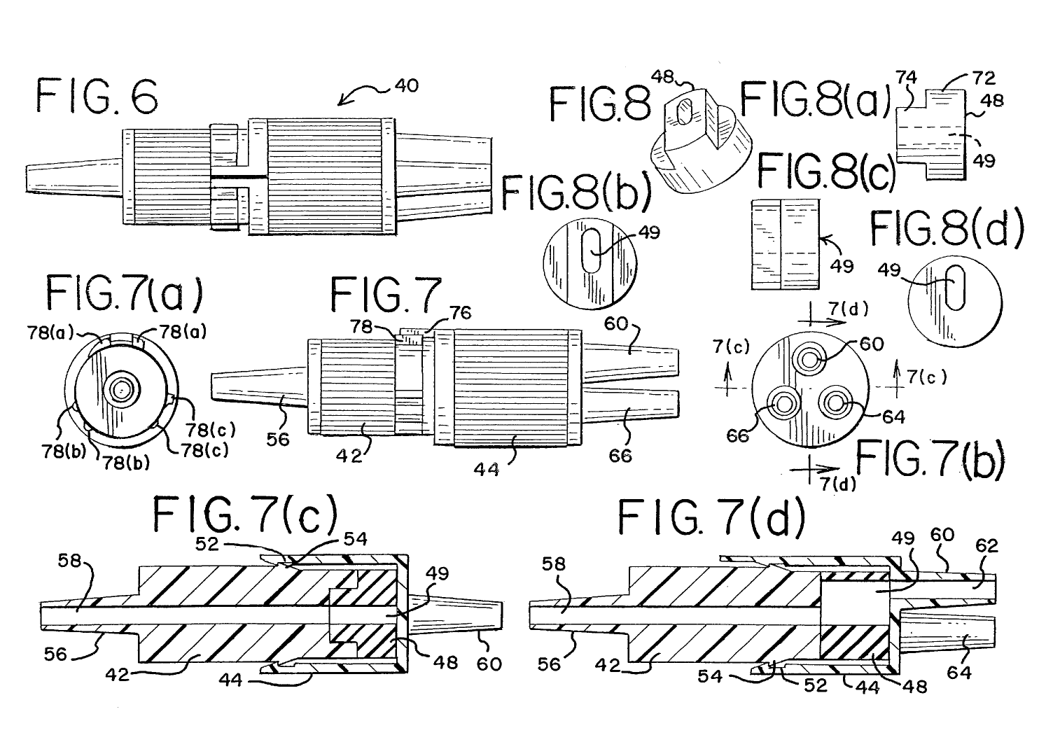

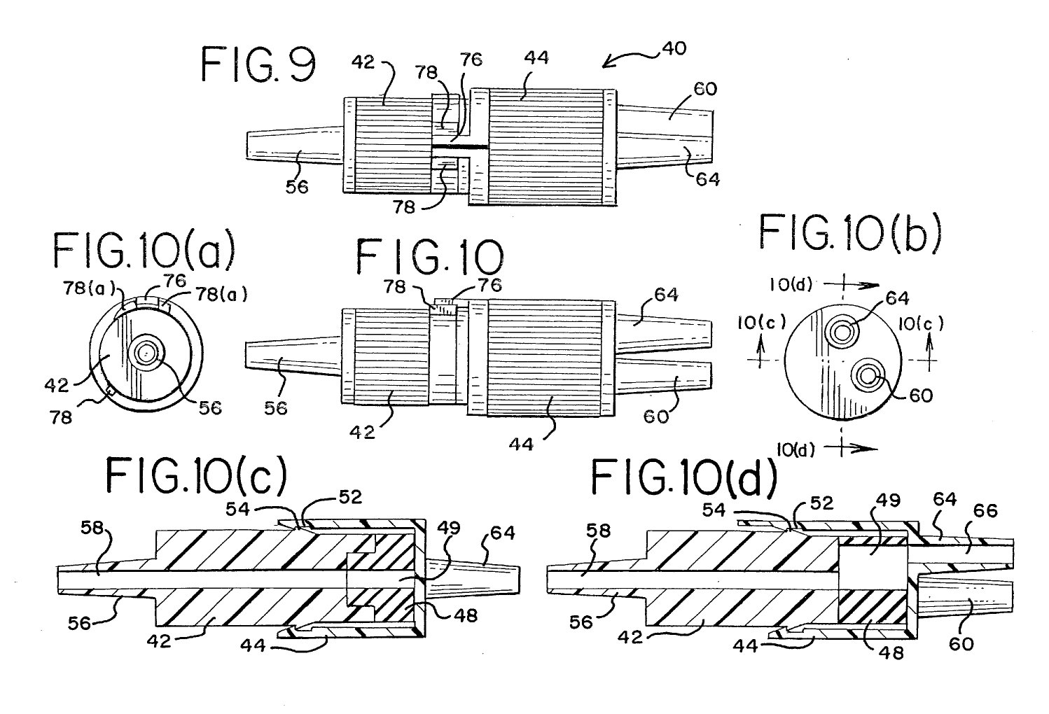

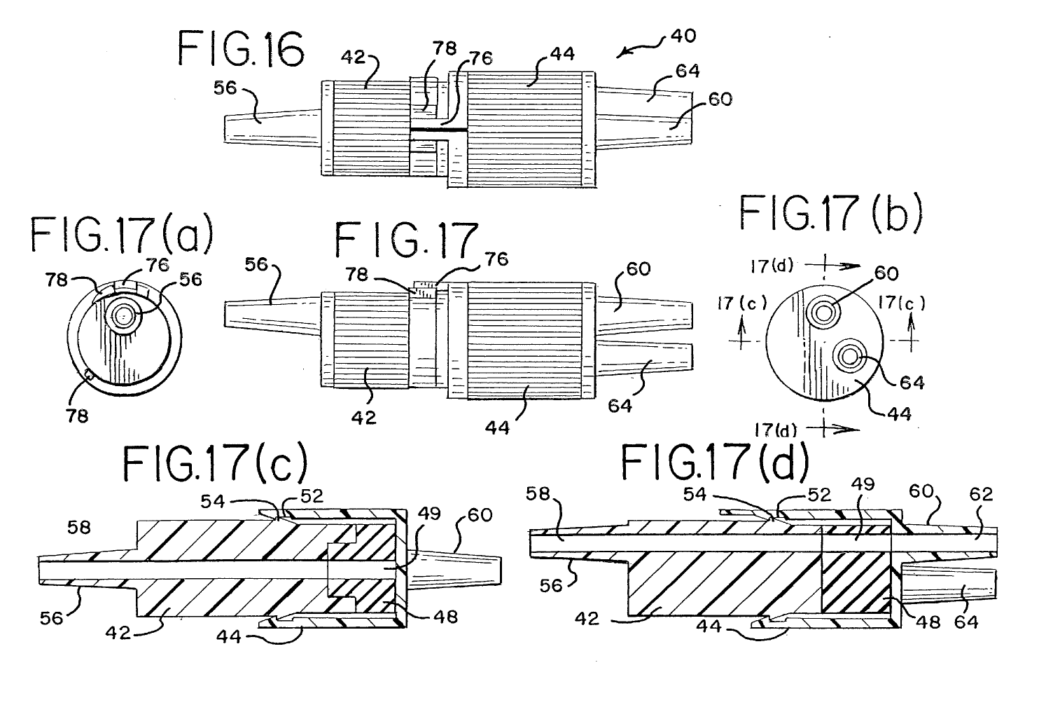

Outlet member 44 includes one or more outlet ports 60, 62 and 64 extending from the distal end of outlet member 44. The number of outlets will depend on the number of destinations for the blood or other fluid to be collected. Thus, where flow from the inlet is to be collected or directed to three separate destinations e.g., containers), flow controller assembly will have three outlets as shown in FIGS. 3-7 and 13-14. Where flow is to be directed to two separate destinations (as, for example, in the fluid circuit of FIG. 2), flow controller assembly may have only two outlets as shown in FIGS. 9-10 and 16-17. Where flow from the inlet is to be directed to a single destination and flow controller assembly 40 acts as an ON/OFF switch, one outlet port may be provided. With reference to FIG. 2, outlet ports 60, 62 and 64 communicate with collection line 22, sample line 18 and other lines as necessary or desired. In the embodiment of FIGS. 3-5 inlet port is coaxial with central axis 46 of flow control assembly 40. Outlet ports 60, 62 and/or 64 are spaced off center and around the central axis 46 and, as shown specifically in the embodiment of FIG. 4, are separated by approximately 120°.

Flow controller assembly 40 may be made of rigid plastic material that is biocompatible and sterilizable by known methods of sterilization for medical products. This may include steam sterilization (or autoclaving) or radiation sterilization. Examples of suitable materials include, but are not limited to polycarbonate polyethylene and polypropylene. As shown in FIGS. 3-5, outer surfaces of flow control assembly 40 and, specifically, inlet members 42 and outlet member 44 may be knurled or otherwise textured to provide easier finger gripping by the user.

Located between inlet member 42 and outlet member 44 is sealing member 48. Sealing member 48 is preferably made of a resilient and biocompatible material such as silicone or rubber. As shown in FIGS. 3-5 and, specifically, FIG. 8, sealing member 48 includes a flow channel 49 extending therethrough. As previously described, flow channel 49 of sealing member 48 is in flow communication with inlet channel 58 and inlet port 56. As further seen in FIG. 8, in one embodiment, sealing member 48 is relatively thick and in the shape of a T-shaped disk. That is, sealing member 48 has a generally cylindrical distal portion 72 and a proximal portion 74. When viewed from one perspective, seen best in FIG. 8A, sealing member 48 defines a T-shaped profile. Proximal end portion 72 of sealing member 48 may be shaped and sized to be press fit and/or keyed into a corresponding notch 52 in the distal end of inlet member 42 as best seen in FIG. 3. Of course, proximal portion 74 of sealing member may be square, or octagonal or provided in a different shape with notch 52 being correspondingly shaped to receive proximal portion 74. Thus, sealing member 48 is preferably carried by inlet member 42. Consequently, because sealing member is mechanically linked to and driven by inlet member, rotation of inlet member 42 rotates sealing member 48 and flow channel 49 accordingly. Variations of suitable drive linkages include a square drive, a slot drive and a star-shaped drive. To aid in rotation of sealing 48 within outlet member 44, the distal surface of sealing member 48 may be lubricated.

Inlet member 42 and outlet 44 are cooperatively associated with one another in a way that allows for relative rotation of members 42 and 44. In one embodiment, outlet member 44 may include a circumferential groove 52 on the inner surface of outlet member 44. Inlet member 42 may include a continuous or semi-continuous circumferential rib 54 as seen in FIG. 4 on the outer surface of inlet member 42. Alternatively, these elements may be reversed with inlet member 42 including a groove on its outer surface and outlet member 44 including a rib on its inner surface. In any event, inlet members 42 and outlet member 44 may be cooperatively associated with one another by snap-fitting the rib 54 into groove 52 and allowing for relative rotation of the members. Thus, the inlet member 42 and outlet member 44 snap together compressing sealing member 48.

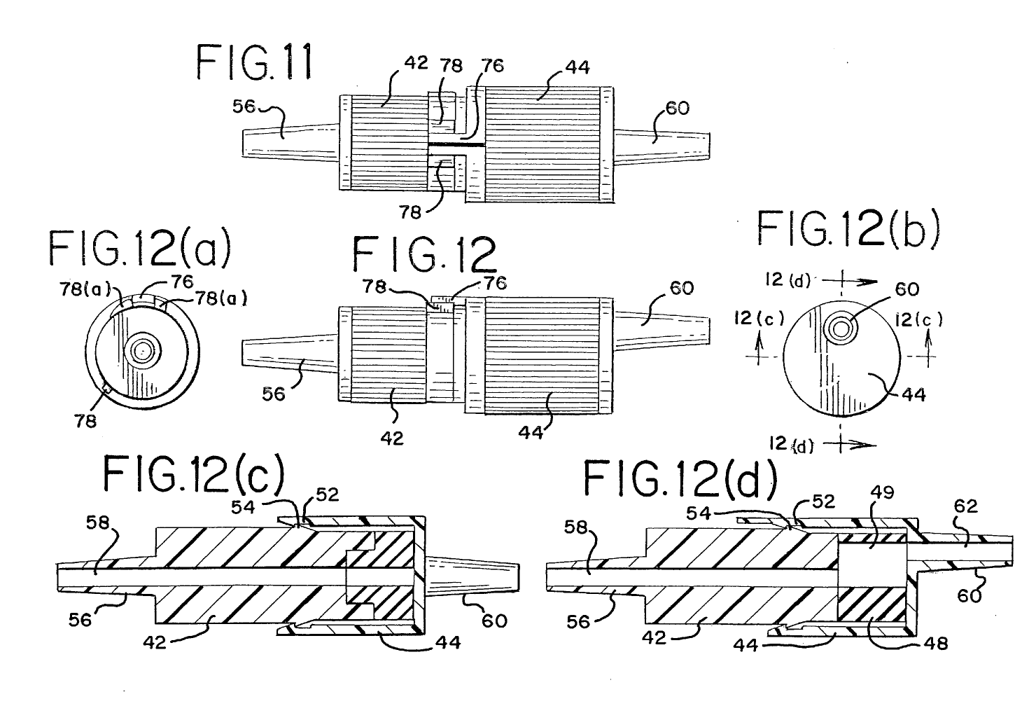

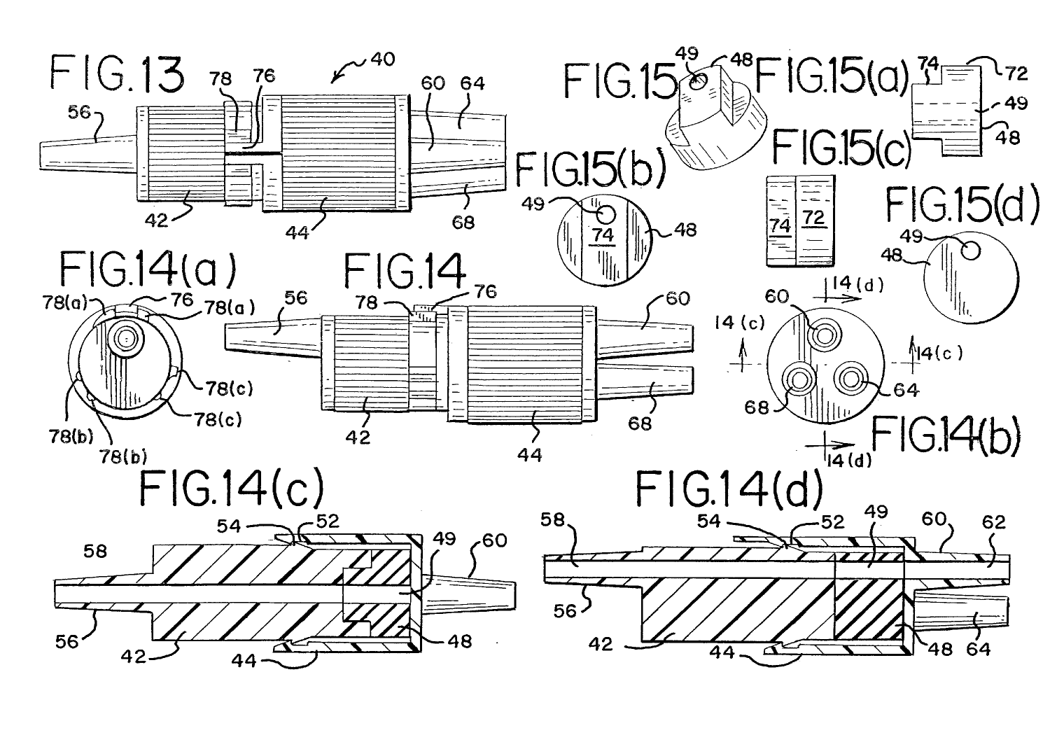

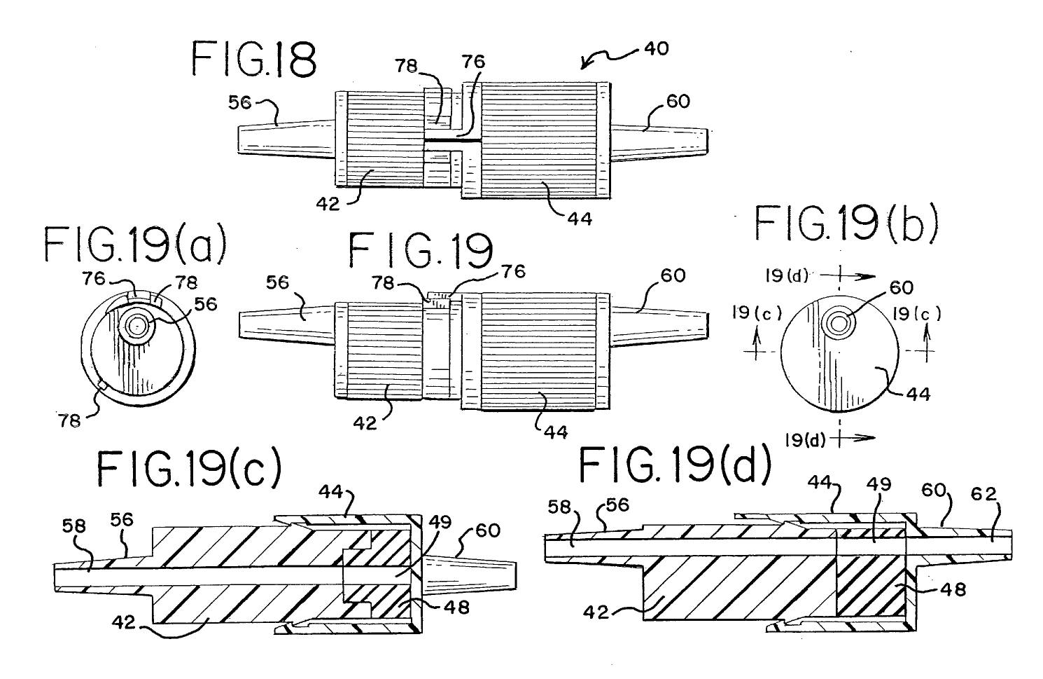

As shown in FIGS. 3-5 and 6-19, outlet member 44 includes an axially extending finger 76. Once flow control assembly 40 is assembled, finger 76 extends beyond the proximal end of outlet member 44. Inlet member 42 includes one or more sets of stops 78 on its outer surface near its distal end allowing for cooperative engagement with finger 76. As shown in FIG. 3, a pair of stops 78 provides a space or gap in which finger 78 is captured and held. This arrangement restricts rotation of relative rotation of inlet member 42 and outlet member 44 as necessary. As seen in FIGS. 5 and 7(a), 10(a), 12(a), stops 78 may be raised surfaces or protuberances extending from the outer surface of inlet member 44. The stops may also be ratchets or other types of catches sufficient to restrict or prevent rotation or movement of finger 76. FIG. 7(a) shows three types of retaining members including a pair of stops (78(a), a pair of detents 78(b) or a combination of a ratchet and stop 78(c). Any other pair or combination of stops, catches, protuberances, detents or other retaining means for limiting, restricting or preventing movement of finger 76 and, thus, outlet member 44 may be employed. The stops or other retaining members described above may be identified by a number or other identifier that corresponds to the outlet that is aligned with or in flow communication with inlet 56. The identifier may be printed or otherwise indicated on inlet member 42 in close proximity to the stops 78. In addition, identifier may be located on outlet member 42 such that when finger 76 is retained by stops 78 or resides in the space between the stops, finger 76 and, more specifically, line marker 77 on finger 76, is aligned with the outlet port identifier. Finger 76 and cooperating stops 78 may be shaped or otherwise dimensioned to either temporarily restrain finger 78, but otherwise allow finger 76 to “ride over” stops or ratchets when rotation and alignment of the ports is desired. In this regard, the surfaces of stops can be curved or rounded as necessary. Alternatively, when no further rotation is desired or the ability to rotate inlet member and/or outlet member back to another position, one stop or one set or pair of stops 78 and/or finger may be dimensioned to prevent such rotation by not allowing finger 76 to ride over the retainer, and create, in effect, a substantially irreversible locking feature.

As shown in FIGS. 3-12, inlet port 56 of inlet member 42 is centered along central axis 46. Flow controller assembly 40 and, more specifically, outlet member 44, may include one or more outlet ports off of and around the central axis 46. In order to establish flow communication between centered inlet port 56 and off-center outlet ports 60, 64 and 68 and, more specifically, the outlet port channels 62, 66 and 70 defined thereby, seal member flow channel 49 will preferably have an oval-like cross-section. Seal member flow channel 49 with an oval-like cross-section is best seen in FIG. 8 and, specifically, in FIGS. 8(a)-8(d). As shown FIGS. 7(d), 10(d) and 12(d), an elongated or oval-like aperture as described above establishes flow communication between centered inlet port 56 and one of outlet ports 60, 64 or 68.

In an alternative embodiment, inlet port 62 may be off-center or otherwise spaced from the central axis 46, with outlets 60, 64 and 68 positioned as described above, i.e., also off-center and placed around central axis 46 of flow controller assembly 40. In this embodiment, sealing member 48 may have a substantially circular cross-section as shown in FIG. 15 generally and FIGS. 15(a)-15(d) specifically.

In each of the embodiments rotation of inlet member 42 and outlet member 44 establishes flow communication from a source to a destination. Where flow controller assembly 40 includes a single inlet and a single outlet, flow control assembly acts as a simple on/off switch which either allows or restricts flow. Where flow control assembly includes multiple outlets, flow control assembly 40 provides the user with the ability to divert flow from one destination (such as container 20) to another destination (such as container 24) or another two destinations. The number of outlets is not limited to three and additional outlets may be included in flow controller assembly 40. The number of outlets will, in part, be determined by the size of flow control assembly 40. Flow control is achieved by twisting one or both of inlet member 42 and outlet member 44 so as to align inlet 56 with the desired outlet 60, 64 and/or 68. A fluid path from the source to the destination is established when the inlet flow channel 58 is aligned with sealing member flow channel 49 and the outlet port flow channel 62 or 66 or 70.

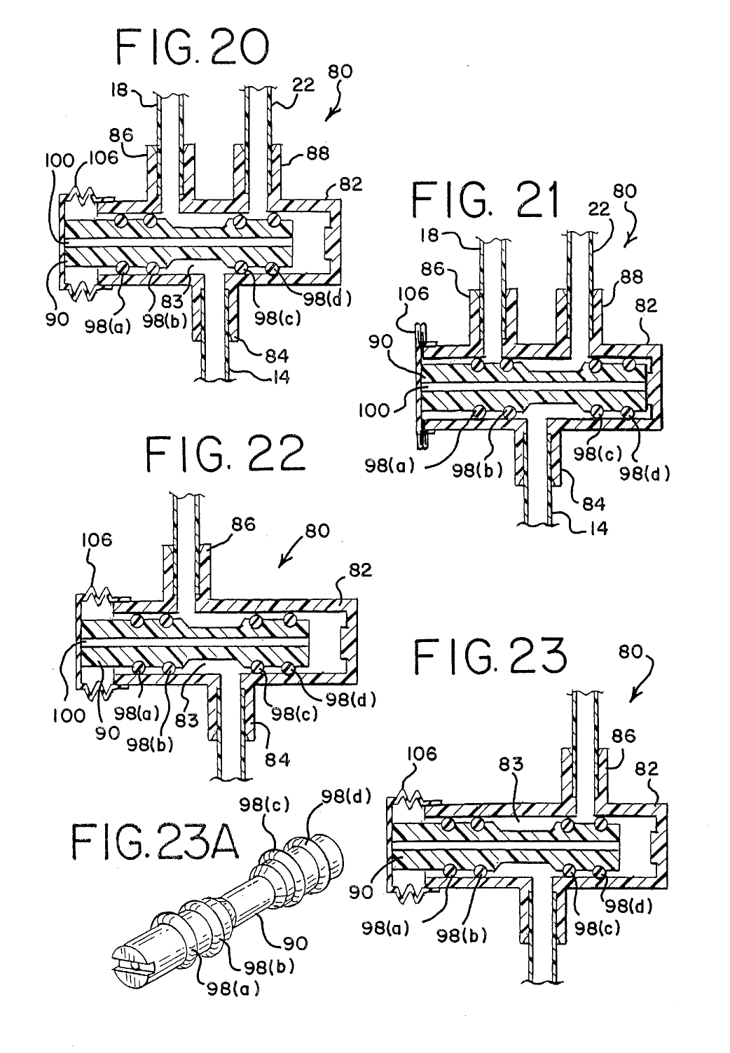

An alternative embodiment of a flow controller is shown in FIGS. 20-23 and is described below. Flow controller 80 of FIGS. 20-23 may likewise serve as a fluid diversion device (as shown in FIGS. 20-21) or ON/OFF switch as shown in FIGS. 22-23. In either embodiment, flow controller 80 includes a housing 82 with one inlet 84 and one or multiple outlet ports 86 and 88, and a movable button 90 adapted for movement within the flow channel 83.

As shown in FIG. 23(a), the button is preferably a cylinder with multiple axial ribs 98 or seals. The button is shaped to be wider at its ends with a narrower diameter in the center, thereby providing a fluid path between inlet 84 and outlet 86 and 88 around this narrow cylindrical section. Bufton 90 can be made as a solid piece, preferably made of biocompatible plastic with glands to accept rubber or silicone O-rings of a selected size. Alternatively, button 90 can be molded as a solid piece with an overmold of a soft material to form the multiple ribs 98 or seals. Button 90 fits into the housing thereby forming an axial fluid seal. A through hole or vent 100 at the center of button 90 serves as a vent for air to escape when button 90 is depressed into housing cavity 83. Housing 82 has open ports 84, 86 and 88 extending from opposing side walls as shown in the Figures.

As shown in FIG. 20, in an initial state, fluid entering inlet 84 can only pass to outlet port 86. Fluid cannot pass to outlet port 88. Seal or rib 98(c) prevents fluid flow to port 88. Seal formed by ribs 98(d) prevents any fluid within outlet port 88 from entering into chamber at distal end of device. When button 90 is depressed, as shown in FIG. 21, the fluid path direction changes. Fluid can only pass from inlet port 84 to outlet port 88. Fluid cannot pass to outlet port 86, as seal 98(b) prevents fluid to pass to port 86. Seal 98(a) prevents any fluid within outlet port 86 from re-entering or dripping back into proximal end of flow controller 80. As shown in FIGS. 20-21, an optional bellows 106 may be provided as a dust shield and as a sterile barrier.

As shown in FIGS. 22-23 depict flow controller 80 may be provided as an ON/OFF switch with 2 ports, an inlet 84 and an outlet 86. Movement of button 90 closes a normally open flow path or opens a normally closed flow path. For example, in FIG. 22, flow controller 80 is configured as a NO (normally open) fluid switch with only two ports. In the initial position, fluid path is open from (bottom) inlet port 84 to (top) outlet port 86. When button 90 is pressed, the flow path is closed and further flow to outlet 86 is prevented by fluid seals 98(a) and 98 (b).

In FIG. 23, flow controller 80 is configured as a NC (normally closed) fluid switch illustrated with only two ports. In the initial position, fluid path is closed. Fluid seals or ribs 98(c) prevent fluid from entering outlet 86. When button 90 is depressed, the flow is open from (bottom) inlet port 84 to (top) outlet port 86.

In another embodiment, flow controller may be provided as an ON/OFF switch where a simple press of the housing wall will open (or close) fluid flow, although more typically, it may be used one time only to open a fluid path. Once open, it is preferably difficult and impractical to return to a closed state.

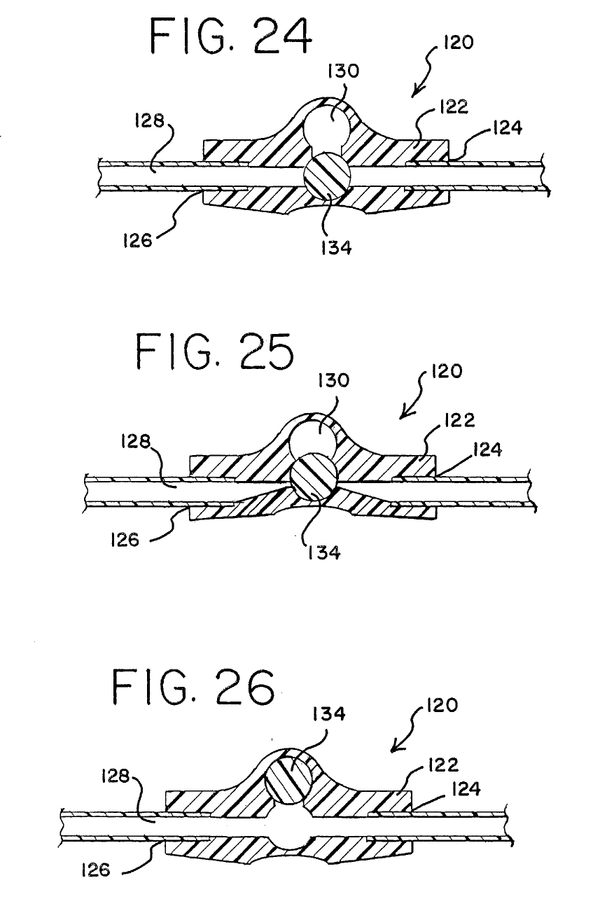

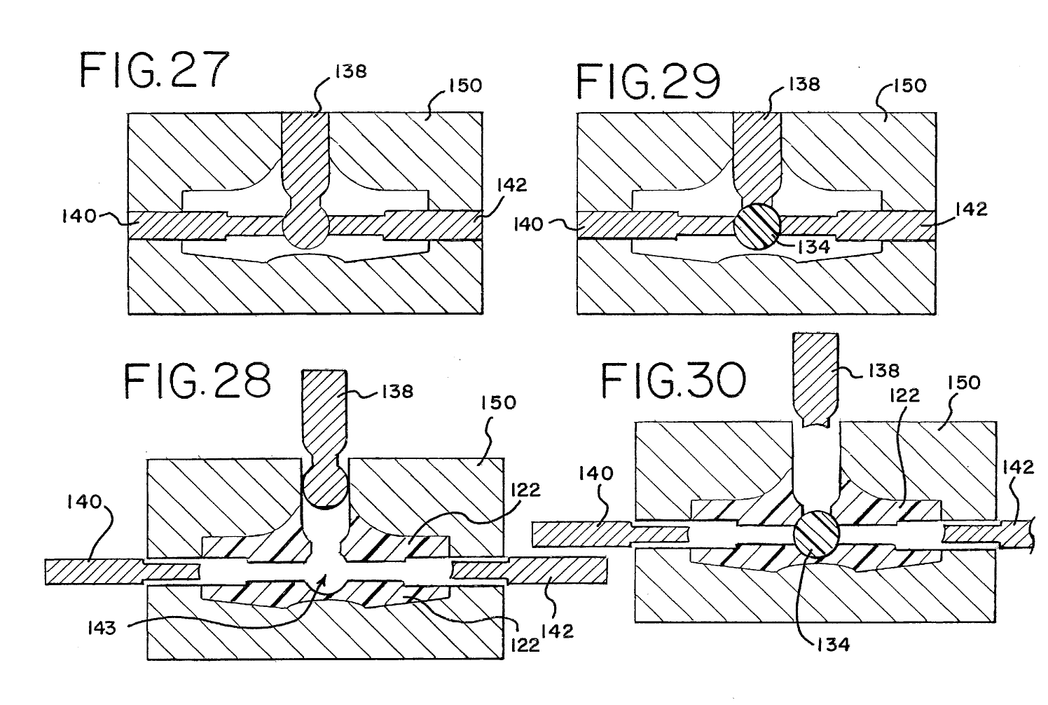

An example of such a flow controller is shown in FIGS. 24-26. Flow controller 120 includes a flexible housing 122 with an inlet port 124 and outlet port 126, Ports 124 and 126 are in flow communication with flow paths 18 and 22 of the fluid circuit 10. A solid ball 134 is located within the center of housing 122. In its initial state, the ball prevents fluid passage. Ball 134 is larger than the port opening, thus creating a seal at high fluid pressure. Above ball 134 is an empty pocket 130 or cavity to accept the ball size. A simple press on the outside of housing 122 will displace and transfer ball 134 into empty pocket 130 thus allowing for a fully open flow path 128 across inlet 124 and outlet 126 port. Housing 122 may include a depression or concave surface resulting in a thinner housing wall at depression 123 where the user may apply pressure to dislodge ball 134 from the flow path. This fluid switch described above is preferably intended for one time use and once flow path 128 is opened it is preferably not intended to be closed again. It is intended to be difficult and impractical to return the ball to its original position.

The ball-actuated flow controller described herein has several advantages over the previous breakable cannula frangible and stopcock devices. For example, flow controller may be activated with one hand operation. When actuated, the fluid path is opened without any restriction. Furthermore, the device is easy to use. Finally, flow controller 120 may be manufactured by a simple molding process.

For example, the ball actuated flow controller 120 may be molded as one piece from a biocompatible and sterilizable material such as polyvinyl chloride, certain medical grade rubbers or other plastics. Ball may be made of a biocompatible plastic, steel or other hard material suitable for use in medical procedures, In one embodiment, as shown in FIG. 29-30, ball 134 is captured and molded within the flexible housing by means of an injection molding process. Ball 134 is preferably made of a material different from the material of housing 122 such that ball 134 will not crosslink with the flexible housing 122 material. Thus, ball 134, when necessary, will be moveable from its original position into the adjacent empty pocket 130. Ports 124 and 126 and flow path 128 are formed with side action core pins 138, 140, 142 known in the molding industry. Core pins 138, 140, 142 hold ball 134 in position as the plastic material fills the mold 150. As shown in FIGS. 28 and 30, the ends of core pins 138, 140 and 142 which contact the surface of ball 134 are shaped to match the curvature of the ball surface or milled with V-bit shape. Core pin ends may also be hollow tubes and ground to match the curve surface of the ball 134. After the material is injected and cools, the core pins retract and form the ports and the empty cavity.

The ball actuated flow controller 120 may also be molded without the ball such that the ball is assembled at a later time as shown in FIGS. 27-28. The spherical cavity 143 created would be smaller in size than the size of the ball. This results in providing a compression seal against the ball once it is insert assembled.

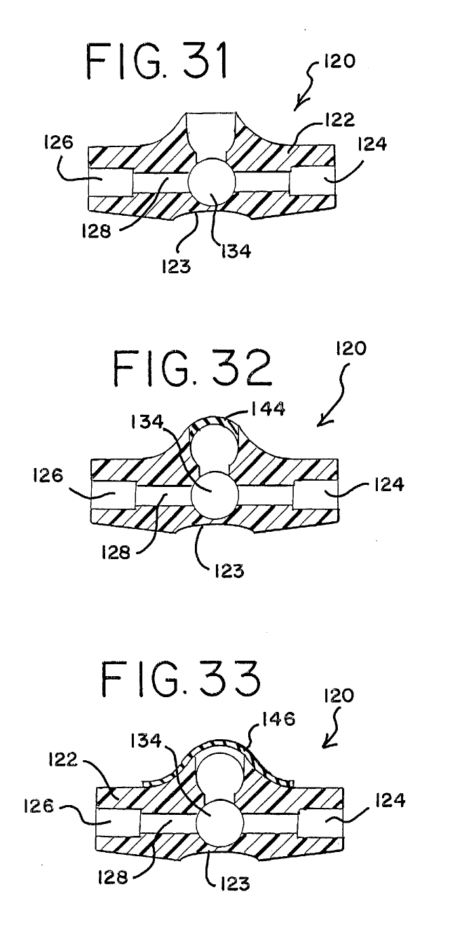

FIG. 31 shows cross section of the device when removed from the mold. In this regard, ball 134 may be introduced into flow controller 120 through the open top of flow controller 120. Once ball 134 has been introduced into spherical cavity 143, a plug or cap 144 may be overmolded or otherwise applied to over the open top to seal flow controller 120. A membrane sheeting 146 may be applied to the open top or applied over plug or cap 144.

The above has been offered for illustrative purposes only, and is not intended to limit the scope of the invention of this application, which is defined in the claims below.

That which is claimed:

1. A flow controller assembly comprising:
an inlet member and an outlet member cooperatively associated with each other and adapted for relative rotation about a central axis;
a sealing member and carried by one of said inlet or outlet members, said sealing member including a single flow channel extending therethrough.

2. The flow controller assembly of claim 1 wherein said sealing member comprises a resilient T-shaped disk comprising a cylindrical distal portion.

3. The flow controller assembly of claim 2 wherein said inlet and outlet members are generally cylindrical.

4. The flow controller assembly of claim 3 wherein said inlet member includes a flow path extending therethrough and communicating with an inlet port.

5. The flow controller assembly of claim 1 wherein said sealing member flow channel has a substantially oval-like cross-section.

6. The flow controller assembly of claim 5 wherein said inlet member flow path has a substantially circular cross-section.

7. The flow controller of claim 2 wherein sealing member is carried by said inlet member and said inlet member is keyed to receive a portion of said plug.

8. The flow controller assembly of claim 3 wherein one of the inlet member or the outlet member comprises an outer surface having an outward rib extending at least partially around said outer surface.

9. The flow controller assembly of claim 8 wherein the other of said inlet or outlet members comprises an inner surface having a circumferential groove thereon for receiving said ring.

10. The flow controller assembly of claim 1 comprising means for restricting rotation of said inlet and outlet members relative to each other.

11. The flow controller assembly of claim 10 wherein said means for restricting rotation comprises an axially extending leg on one of said inlet or outlet members and one or more stops on the other of said inlet or outlet members.

12. The flow controller assembly of claim 11 wherein said one or more stops comprise a pair of stops extending from the outer surfaces of said housing.

13. The flow controller assembly of claim 11 wherein said one or more stops comprise at least one ratchet.

14. The flow controller assembly of claim 11 wherein said inlet member comprises an inlet port along the central axis and the outlet member includes at least two outlets positioned about said central axis and spaced at least 90° from each other.

15. The flow controller assembly of claim 14 wherein said outlet member includes 3 outlet ports positioned about said central axis and spaced approximately 120° from each other.

16. A fluid processing circuit comprising:
a first flow path adapted for communication with a fluid source;
a second flow path;
a flow controller assembly between said first and second flow paths, said flow controller assembly comprising having a first portion, a second portion cooperatively associated with each other and adapted for relative rotation about a central axis, said flow controller assembly further comprising a sealing member between said portions and carried by one of said portions, said sealing member having a single flow channel extending through said sealing member, said flow controller assembly including an inlet port communicating with said first flow path and an outlet port communicating with said second flow path.

17. The fluid processing circuit of claim 16 comprising at least two containers for receiving fluid from said fluid source.

18. The fluid processing circuit of claim 17 wherein said outlet member includes at least two outlet ports.

19. The fluid processing circuit of claim 18 wherein said sealing member channel has a substantially oval-like cross-section.

20. The fluid processing circuit of claim 16 wherein at least one of said portions includes a flow path extending from said inlet port, through said first or second portion and said sealing members.
